(19) United States
(12) Patent Application Publication
(10) Pub. No.: US 2012/0331303 A1
(43) Pub. Date: Dec. 27, 2012

(54) METHOD AND SYSTEM FOR PREVENTING EXECUTION OF MALWARE

(76) Inventors: Jonathan E. ANDERSSON, Round Rock, TX (US); Shannon Cash, (US); Guy A. Stewart, (US)

(21) Appl. No.: 13/166,849

(22) Filed: Jun. 23, 2011

(51) Int. Cl. G06F 21/00

(52) U.S. Cl. 713/189

(57) ABSTRACT

A method and system for preventing execution of malware in a computing device. The method includes loading code into a non-executable memory of the computing device and validating an authentication signature associated with the code. Subsequently, the code is decrypted and finally, the decrypted code is executed in an executable memory upon a determination that the authentication signature is valid.

### BACKGROUND

This application deals generally with the field of malware, and more specifically with detection of malware.

As more and more computers and computing devices are interconnected through various networks such as the Internet, security has become increasingly important, particularly from invasions or attacks delivered over a network or over an information stream. These attacks come in many different forms, such as viruses, worms, and Trojans, which exploit one or more computer system vulnerabilities for illegitimate purposes. While those skilled in the art will recognize that various computer attacks are typically distinct from one another, for purposes of the description, all malicious computer programs are referred to as malware. In general, malware damages, degrades, or infiltrates a computing device without the owner's consent.

Secure Integrated Circuits (ICs) employ a number of security features to prevent loading suspicious code in order to guard against attacks. Such techniques also aim to avert cryptographic fault induction attacks, which are attacks that enable execution of suspicious code. The features, however, often fail to keep up with new attacks occurring on a daily basis. Moreover, when booting the IC, these features may not yet be initialized and are vulnerable to bypass or tampering.

To overcome these attacks, a number of hardware and software techniques have been suggested. Hardware techniques include adding silicon resources to the IC, such as hardened reset circuitry or additional ESD protection. Other additions could include techniques like power conditioning (brownout/overvoltage protection) and internal oscillators. Hardware solutions, however, are expensive.

Software techniques include measures such as implementation of shadow stacks (manual, duplicate stacks which track and verify program flow control), verifying signatures, and encryption algorithms. Software solutions, however, tend to increase the level of effort required to mitigate the risk of attack. For example, before boot loading the IC, the digital signatures associated with the boot code are verified to identify the malware. Attackers, however, may force execution of the malware by skipping the signature verification step through various means such as inducing glitches or clock manipulation.

It would be highly desirable to have a simple and effective mechanism for preventing the execution of malware to provide resistance towards undesired attacks.

### SUMMARY

The present disclosure describes a method for preventing execution of malware in a computing device. The method includes loading code from an external device into a non-executable memory of the computing device and validating an authentication signature associated with the code. Subsequently, the code is decrypted and the decrypted code is executed within an executable memory upon a determination that the authentication signature is valid.

Another embodiment of the present disclosure describes a system that prevents execution of malware. The system includes an executable memory and a non-executable memory that receives code from an external device. Executable and non-executable memory is memory sections where instruction execution is enabled and disabled, respectively. The system also includes a processor that verifies an authentication signature associated with the code and decrypts the code. The processor then executes the decrypted code within the executable memory upon a determination that the authentication signature is valid.

### BRIEF DESCRIPTION OF THE DRAWINGS

The drawings described below set out and illustrate a number of exemplary embodiments of the disclosure. Throughout the drawings, like reference numerals refer to identical or functionally similar elements. The drawings are illustrative in nature and are not drawn to scale.

FIG. 1 illustrates an exemplary system that prevents execution of malware on an Integrated Circuit (IC) according to the present disclosure.

FIG. 2 illustrates an alternate embodiment of a system that prevents execution of malware on the IC, shown in FIG. 1.

FIG. 3 is a flowchart of an exemplary method for preventing execution of malware.

FIG. 4 is flowchart of an alternate exemplary method for preventing execution of malware.

### DETAILED DESCRIPTION

The following detailed description is made with reference to the figures. Exemplary embodiments are described to illustrate the subject matter of the disclosure, not to limit its scope, which is defined by the appended claims.

### Overview

The present disclosure describes a method and system for preventing execution of malware in a computing device. The method ensures that a block of code or firmware received from an external source is loaded into a non-executable memory of the device. A processor verifies an authentication signature associated with the code and subsequently, decrypts the code within the non-executable memory. The decrypted code is then executed using an executable memory upon a determination that the authentication signature is valid.

The malware detection technique prevents malware from entering the executable memory. The code block is simultaneously authenticated and decrypted within the non-executable memory. If the code is valid and encrypted using a correct security key, the executable memory receives authenticated and decrypted code that can be executed accordingly. Because malware is either non-encrypted or encrypted using an incorrect security key, decryption of the malware produces non-executable data. Consequently, the malware reaches the executable memory as unauthenticated and non-executable code. As a result, the present disclosure prevents execution of malware, thus providing resistance against attacks.

Aspects of the present disclosure may assist in implementing secure boot loading of a secure integrated circuit (IC). As boot code received from an external source may not be authentic, the present disclosure prevents the entry of the suspicious code in the executable memory of the IC in executable form. The embodiments described below prevent execution of malware using an exemplary boot-loading procedure for a secure IC. The present disclosure, however, is not limited to the particular boot-loading procedure disclosed. As would be appreciated by one of ordinary skill in the art, the malware detection technique applies to any computing device that prevents executing suspicious code or firmware loaded from an external device.

### Exemplary Embodiments

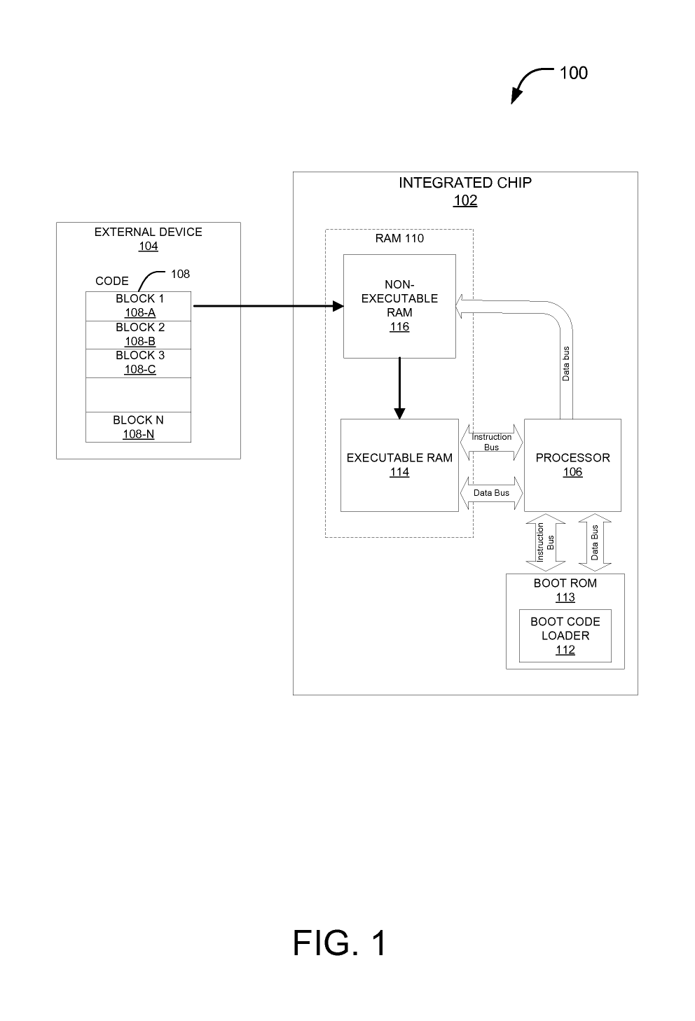

FIG. 1 illustrates an exemplary embodiment of a system 100 that allows an Integrated Circuit (IC) 102 to boot securely from an external memory device 104. The IC 102 includes a processor 106 operable to perform functions such as boot loading by executing boot code 108 stored in the external device 104. An internal Random Access Memory (RAM) 110 stores code executed by the processor 106. A boot code loader 112 fetches the boot code 108 from the external memory 104 into the RAM 110. The boot code loader 112 may be stored in the IC 102 in any type of non-volatile memory including ROM, EEPROM, Flash, OTP (One Time Programmable). The embodiment of the present disclosure depicts the boot code loader 112 stored in Boot Read Only Memory (ROM) 113.

The system 100 provides a security mechanism for secure booting, by executing only secure boot code. To this end, the RAM 110 is divided into two sections—an executable RAM 114 and a non-executable RAM 116. First, the boot code 108 is loaded into the non-executable RAM 116 where the processor 106 verifies the authenticity of the code 108 before transferring it to the executable RAM 114 for execution. Further, the code 108 is decrypted in the non-executable RAM 116. Those skilled in the art will appreciate that decrypting malicious code will result in non-executable data. By decrypting and simultaneously authenticating the boot code 108 in the non-executable RAM 116, the present disclosure prevents the processor 106 from ever executing unauthenticated code during the boot phase.

The system 100 may be embodied in any known secure IC, such as the IC 102, used in a variety of different devices for multiple purpose applications. The IC 102 may provide different services or functions such as telephone, video, audio, Internet access and so on. In an embodiment of the present disclosure, the IC 102 may be an embedded controller, smart card or similar integrated circuits.

The IC 102 includes the RAM 110 for storing the boot code 108 received from the external device 104. As discussed, the RAM 110 is divided into two sections—the executable RAM 114, from which the execution of code is authorized, and the non-executable RAM 116, from which the code execution is not allowed. For illustration purposes, the system 100 depicts the RAM 110, those skilled in the art, however, will understand that any known modifiable memory device such as DRAM, SRAM may be employed.

The external memory device 104 may be coupled to the IC 102 via secure and/or unsecure networks to provide boot components to the IC 102. It should be understood that firmware loaded from an external memory device might not be secure. In addition, the external device may be coupled to the IC 102 through wired or wireless means such as a USB interface, or Bluetooth®. The external device 104 may include any known computing device or may be a suitable memory device, such as a NAND flash, NOR flash, or hard disk.

The boot code 108 may include boot components required to boot the IC 102. Typically, the boot code 108 may be “large size” executable code. The term “large size” refers to the code larger than the size of the executable/non-executable RAM or the RAM available. Consequently, the code 108 is divided into blocks 108-A, 108-B, and so on. The code 108 may be divided into any number of blocks, and these blocks may be loaded into the non-executable RAM 116 in a specified sequence. In another embodiment of the present disclosure, code division may not be required, and therefore only one block of code is loaded into the non-executable RAM 116.

The boot code 108 loaded from the external device 104 may be secure or malware. The term “secure boot code” describes program instructions, interpretable or executable by a processor such as the processor 106, and known to the processor to be trustable. Secure code might, for example, be known to be trustable by virtue of having been maintained in persistent memory in the IC 102. In addition, the code 108 can be established as “secure code” by virtue of having been received from a trusted source. Those skilled in the art will comprehend that only secure boot code should be executed on IC 102 to mitigate the risk of cryptographic fault induction attacks. The terms “secure code”, “trusted code”, and “authenticated code” are interchangeably used throughout the disclosure.

To validate the authenticity of secure boot code, the boot code 108 may include implementation of data encoding, encryption, authentication signature and other known techniques. In general, a request from the IC 102 for accessing the boot code 108 is responded by encrypting the boot code 108 using an appropriate security key, which is shared with the IC 102. At the IC 102 end, the processor 106 decrypts the encrypted code 108 using the same security key to generate executable code. In an embodiment of the present disclosure, the boot code 108 may include implementations of data encrypting algorithms such as AES (Advanced Encryption Standard) encryption. Those skilled in the art will appreciate that any known data encryption techniques may be employed to provide security features to the IC 102. In addition, the code 108 is signed with an authentication or a digital signature that validates the code 108.

Suspicious boot code that may damage the secure IC 102 is referred to as malware. It should be understood that malware either contains no encryption or unauthentic encryption. Because only the external device 104 and the IC 102 are aware of the security key, any attempt to replace the secure boot code 108 by malware will result in incorrect decrypted code making the code inoperable. Decryption of malware results in non-executable data referred to as scrambled data. Further, the malware generally does not contain a signature or contains an invalid signature. The terms “malicious code”, “malware”, and “suspicious code” are interchangeably used throughout the disclosure.

The processor 106 ensures secure boot loading for the IC 102. During boot loading, the processor 106 validates the authentication signature associated with the code 108 present in the non-executable RAM 116. As the code 108 is divided into blocks, the processor 106 accumulates the signature associated with each block. The processor 106 also decrypts the code blocks loaded into the non-executable RAM 116 and transfers the decrypted code to the executable RAM 114. Decryption of the code 108 in the non-executable RAM 116 results in executable code or scrambled data. Subsequently, the processor 106 executes the executable boot code loaded into the executable RAM 114. The processor 106 may be any suitable type of processor, such as, but not limited to, a CPU, graphics processor core, or other suitable programmable processing circuitry.

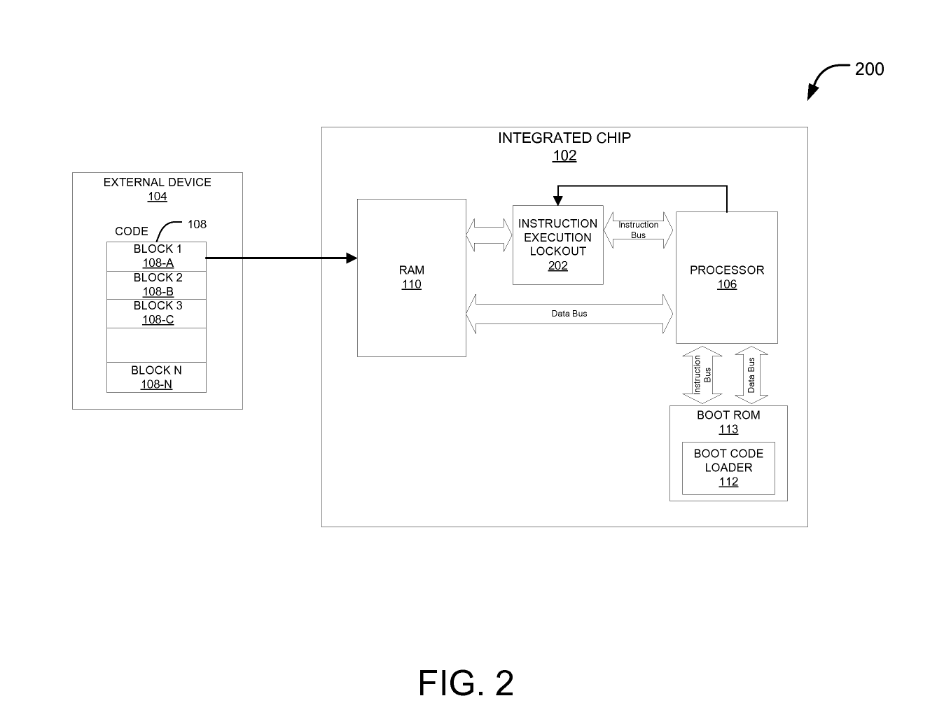

It should be understood that the system 100 is exemplary in nature and several variations can be contemplated without departing from the scope or purpose of the claimed invention. FIG. 2 illustrates an alternate embodiment of the system 100 that allows the Integrated Circuit (IC) 102 to boot securely from the external memory device 104. The IC 102 includes the RAM 110, which may not be divided into sections (as shown in FIG. 1). Instead the RAM 110 switches from being non-executable to executable based on the authenticity of the boot code 108. To this end, the embodiment depicted in FIG. 2 includes an instruction execution lockout module 202 that either disables or enables the processor's ability to execute code stored in the RAM 110.

As shown, RAM 110 includes a single section that is initially disabled for code execution by the lockout module 202. The boot code loader 112 loads the block 108-B from the external device 104. The non-executable RAM 110 does not allow execution of instructions. Subsequently, the processor 106 verifies the authentication signature associated with the block 108-B. Once the signatures are verified, the lockout module 202 switches the RAM 110 to executable memory that enables code execution. In case the signatures are invalid, the present embodiment flags the code 108 as un-trusted to prevent its execution.

There are a number of mechanisms that could be used to control the instruction execution from a memory such as RAM 110. For example, a Harvard architecture machine may provide this feature by using a separate storage and pathway for instructions and data. The decoder on the instruction pathway can be disabled for suspicious code and decoding is enabled only once the signature associated with the code 108 is verified and the code is decrypted. In another implementation, a Von Neumann architecture that uses a single pathway and storage to hold instructions and data may also be employed, and instruction fetches to the region of the RAM 110 containing the suspicious code will fail. Here, the decoder is modified and may require performing a special function such as writing to a special register prior to an instruction fetch. Inappropriate writing to the register will result in code execution failure.

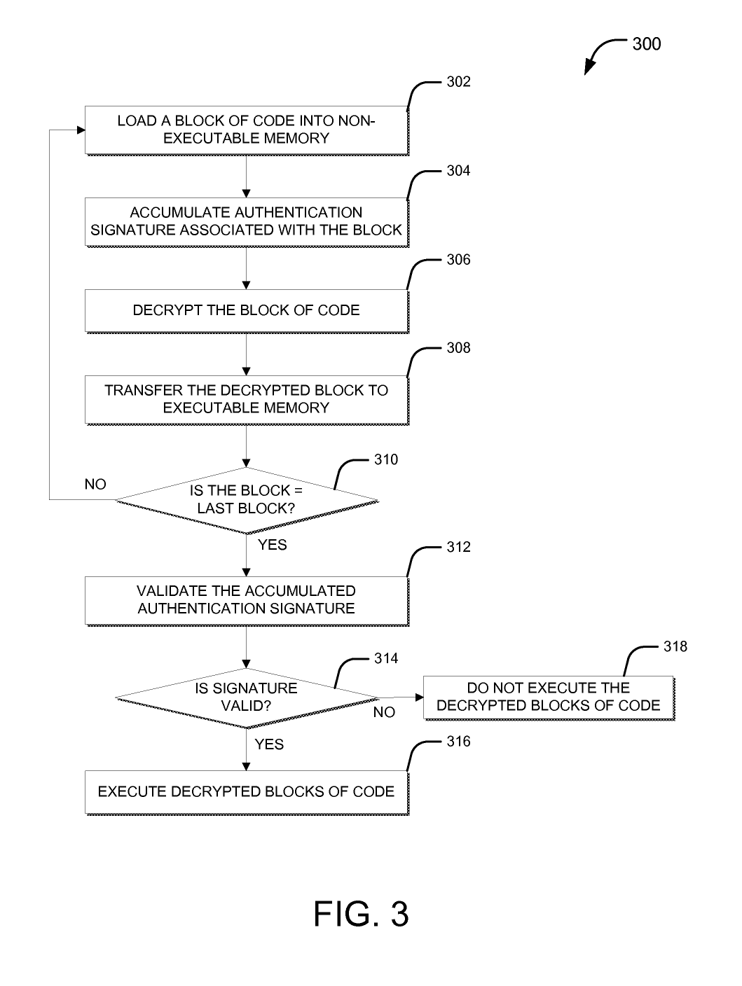

FIG. 3 outlines an exemplary method 300 for preventing execution of malware. The method 300 provides resistance to a computing device against cryptographic attacks when loading firmware or code from an external source. The computing device includes an internal memory having an executable section and a non-executable section. The method 300 may be implemented on the IC 102 (FIG. 1) to perform secure booting. As discussed, the firmware such as the boot code 108 is generally large in size and divided into blocks based on the size of the internal memory.

The method 300 begins at step 302 where a code block is loaded into the non-executable memory. When the IC 102 turns on or requires software updates, the IC 102 requests for assessing the code 108 stored in the external device 104. In response, the block 108-A is loaded into the non-executable RAM 116 using the boot code loader 112.

At step 304, an authentication or digital signature associated with the block of code is accumulated. The processor 106 identifies the authentication signature associated with the block 102-A, and stores this signature in the non-executable RAM 116 for validation purposes. As the code 108 is divided into blocks, appropriate signature verification will be possible only when all the blocks are loaded into the non-executable RAM 116 and corresponding signatures are assembled.

At step 306, the block of code loaded into the non-executable memory is decrypted. Those skilled in the art will comprehend that known encryption or encoding techniques are commonly employed by systems while loading code from an external source to avoid cryptographic attacks. Typically, the code is encrypted using a security key and this security key is provided to the computing device to implement successful code decryption. As discussed, decryption of malware, which is not encrypted, results in scrambled data.

At step 308, the decrypted code is transferred to the executable memory such as the executable RAM 114. Next, the method 300 verifies whether the code block loaded was the last block at step 310. The method 300 ensures that all the blocks of the code, such as the code 108, are loaded into the non-executable RAM 116. In an embodiment of the method 300, the code may not be divided into blocks based on its size, and only a single block of code is required to be loaded. In case all the blocks of code are not loaded, the method 300 jumps back to step 302 where the next block of code is loaded into the non-executable memory. The method steps 302 to 308 repeat until the last block of code is loaded.

Once all the blocks of code are loaded and the corresponding signatures are accumulated, at step 312, the method 300 validates the accumulated signature. At step 314, the method 300 identifies whether the signature is valid. In case the signature is valid, the method 300 executes the decrypted blocks of code transferred to the executable memory at step 316. In case the signature is not valid, at step 318, the method 300 does not execute the decrypted blocks of code as invalid signature identifies the code as malware.

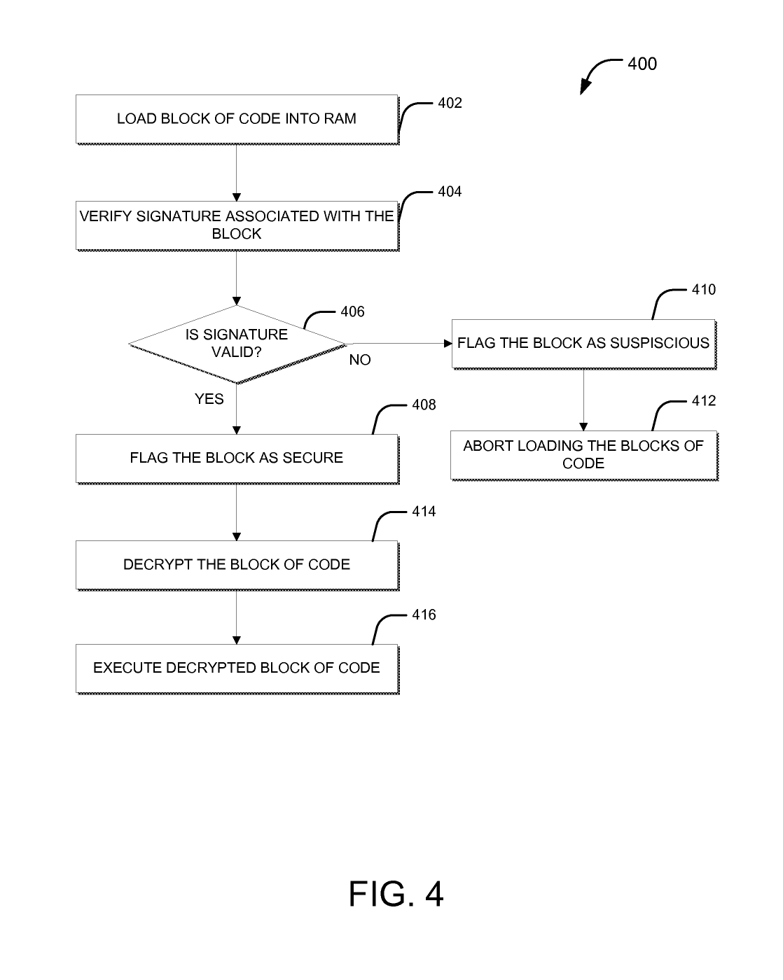

FIG. 4 illustrates another embodiment of a method 400 for preventing execution of malware. The method 400 may be implemented on the IC 102 (FIG. 1) to perform secure booting. The IC 102 includes the RAM 110 that includes a single section that switched between being executable and non-executable, as discussed in FIG. 2. In another implementation, the RAM 110 may be divided into executable and non-executable RAM (FIG. 1).

The method 400 begins at step 402 where a code block is loaded into the RAM 110. The boot code loader 112 loads a block such as the block 108-B into the non-executable RAM 116, where execution of code is disabled. In one implementation, the block 108-B is loaded into the non-executable RAM 116. In another implementation, the code 108 may not be divided into blocks based on its size, and only a single block of code is required to be loaded.

At step 404, the digital or authentication signature associated with each block of code is verified. Those skilled in the art will understand that each block of code may include the complete signature and therefore, each block may be validated individually. Based on the signature, the method 400 flags the code as suspicious or secure. At step 406, the method 400 verifies whether the block 108-B is secure. In case the signature associated with the block 108-B is valid, the method 400 flags the block as secure, at step 408.

In case the signature associated with the block 108-B is not valid, the block is flagged as suspicious at step 410. Flagging the block as suspicious ensures that the block of code is never executed in the memory. To this end, the block of code is either never transferred to the executable RAM 114 or the RAM 110 is not enabled to execute the block. At step 412, the method 400 aborts loading the rest of the code blocks as the code 108 is identified as malware.

In case the block 108-B is flagged as secure, at step 414, the method 400 decrypts the block 102-B. Decryption of the secure block of code results in executable data. Subsequently, this executable data is executed at step 416. In one implementation, the block 108-B is transferred to the executable RAM 114 for execution. In other implementation, the RAM 110 is enabled to execute the secure block 108-B.

It should be understood that the method 400 is described for boot code 108 that is encrypted and signed with an authentication signature. In a first situation, the code 108 may not be signed with an authentication signature, but is encrypted using a key. In a second situation, however, the code 108 may be signed, but may not be encrypted.

In the first situation, the method 400 may not verify any signature associated with the blocks of code. As a result, steps 404 to 412 are not performed by the method 400; instead each block of code loaded into the RAM 110 is decrypted and subsequently, enabled for execution. As suspicious code is encrypted using incorrect key, decryption of code block will result in scrambled data, which will not be executed. In case of the second situation, the decryption of the blocks performed at method step 414 is skipped, and the secure code is directly executed.

The method and system discussed in the present disclosure provides a mechanism to prevent execution of suspicious code on a secure computing device by validating and decrypting the code within a non-executable memory or memory disabled for execution. As validation and decryption steps are implemented within the non-executable memory, the executable memory receives authenticated and decrypted code that may be referred to as secure code, or unauthenticated and scrambled code that cannot be executed and considered malware. In either case, a malicious user is unable to inject executable malware into the executable memory of the secure IC device.

Those in the art will understand that the steps set out in the discussion above may be combined or altered in specific adaptations of the disclosure. The illustrated steps are set out to explain the embodiment shown, and it should be anticipated that ongoing technological development will change the manner in which particular functions are performed. These depictions do not limit the scope of the present disclosure, which is determined solely by reference to the appended claims.

We claim:

1. A method for preventing execution of malware, the method comprising:
loading code into a non-executable memory;
validating an authentication signature associated with the code;
decrypting the code; and
executing the decrypted code within the executable memory upon a determination that the authentication signature is valid.

2. The method of claim 1, wherein the code is divided into a set of blocks before the loading step.

3. The method of claim 2, wherein the loading step includes loading each block into the non-executable memory.

4. The method of claim 2, wherein the validating step includes accumulating the authentication signature associated with each block from the set of blocks and validating the accumulated authentication signature.

5. The method of claim 2, wherein the validating step includes flagging the block of code as secure in case the authentication signature is valid.

6. The method of claim 2, wherein the validating step includes flagging the block of code as suspicious in case the authentication signature is invalid.

7. The method of claim 4, wherein the decrypting step includes decrypting each block from the set of blocks.

8. The method of claim 7, wherein the executing step includes executing the decrypted code for the set of blocks upon a determination that the accumulated authentication signature is valid.

9. The method of claim 1, wherein the decrypting step results in executable data when the code is encrypted using an appropriate key.

10. The method of claim 1, wherein the decrypting step results in non-executable data when the code is encrypted using an inappropriate key.

11. The method of claim 1, wherein the executing step includes transferring the decrypted code from the non-executable memory to the executable memory prior to the execution.

12. The method of claim 1, wherein the executing step includes converting the non-executable memory into the executable memory upon a determination that the authentication signature is valid.

13. A system for preventing execution of malware, the system comprising:
a non-executable memory configured for receiving code to be executed;
an executable memory; and
a processor configured for:
verifying an authentication signature associated with the code loaded into the non-executable memory;
decrypting the code;
executing the decrypted code within the executable memory upon a determination that the authentication signature is valid.

14. The system of claim 13, wherein the memory is Read Access Memory (RAM).

15. The system of claim 13, wherein the processor decrypts the code to provide executable data when the code is encrypted using an appropriate key.

16. The system of claim 13, wherein the processor decrypts the code to provide non-executable data in case the code is encrypted using an inappropriate key.

17. The system of claim 16, wherein the code resulting in non-executable data having an invalid authentication signature is malware.

18. The system of claim 13, wherein the processor is further configured for transferring the decrypted code from the non-executable memory to the executable memory.

19. The system of claim 13, wherein the processor is further configured for switching the non-executable memory to the executable memory upon a determination that the authentication signature is valid.

20. The system of claim 13, wherein the code includes at least one of:
encryption; or
authentication signature.
